(19) United States
(12) Patent Application Publication
(10) Pub. No.: US 2004/0020896 A1
(43) Pub. Date: Feb. 5, 2004

(54) Tapered optical fiber for fiber to waveguide interconnection

(75) Inventors: Samhita Dasgupta, Niskayuna, NY (US); Christopher J. Kapusta, Duanesburg, NY (US); Min-Yi Shih, Niskayuna, NY (US); Stacey J. Goodwin, Niskayuna, NY (US)

Correspondence Address: Townsend and Townsend and Crew LLP, Two Embarcadero Center, 8th Floor, San Francisco, CA, 94111, US

(73) Assignee: Lockheed Martin Corporation, Bethesda, MD (US)

(21) Appl. No.: 10/367,592

(22) Filed: Feb. 13, 2003

Related U.S. Application Data
(60) Provisional application No. 60/356,729, filed on Feb. 15, 2002.

(51) Int. Cl. B29D 11/00

(52) U.S. Cl. 216/24

(57) ABSTRACT

Embodiments of the present invention are directed to a method of processing an optical fiber to match the optical field coming out of the fiber to that accepted into the optical waveguide to reduce the optical losses due to the optical mode mismatch of the interconnection. In one embodiment, a method of tapering an end of an optical fiber comprises providing a flow of etch vapor from an etch solution generally in an etch vapor flow direction, a concentration of the etch vapor decreasing with distance in the etch vapor flow direction; providing an optical fiber have an end portion with a tip, the end portion of the optical fiber including a core and a clad; and subjecting the end portion of the optical fiber to the flow of etch vapor from the etch solution to etch the end portion and form a taper at the end portion. The end portion is disposed generally along the etch vapor flow direction and the tip of the end portion points generally in a direction opposite from the etch vapor flow direction.

### CROSS-REFERENCES TO RELATED APPLICATIONS

This application is based on and claims the benefit of U.S. Provisional Patent Application No. 60/356,729, filed Feb. 15, 2002, the entire disclosure of which is incorporated herein by reference.

### STATEMENT AS TO RIGHTS TO INVENTIONS MADE UNDER FEDERALLY SPONSORED RESEARCH OR DEVELOPMENT

NOT APPLICABLE

### BACKGROUND OF THE INVENTION

The present invention relates generally to fiber optics and, more particularly, to a method of making a tapered optical fiber for connection to an optical waveguide.

Optical fiber communication systems and optical fiber based instruments and devices require the accurate alignment and reliable attachment of optical fibers with integrated optical devices. To provide efficient coupling between the integrated device and the optical fiber, it is necessary to align the fiber with the relevant part of the integrated device with great accuracy, often to within 0.5 microns or less. Even when there is perfect alignment of the fiber and waveguide ends, loss in optical signal strength is introduced through the inherent size mismatch between the fiber and the waveguide structures. Typical fiber core sizes are around 8 microns in diameter whereas a typical waveguide structure is a rectangular feature with dimensions of 5 microns by 2 microns. In order to minimize the loss due to the “modal” mismatch, shaping of either the waveguide to match the fiber or the fiber to match the waveguide have to be performed. For example, optical devices for electric field sensing such as Mach-Zender interferometers are being introduced into real world applications. A long standing problem in the implementation of these optical devices has been the difficulty in fabricating fiber optic interconnects to the devices so that information may be transferred to and from the devices. A typical junction between a single mode optical fiber and a planar single mode optical waveguide results in an optical loss of about 4 dB due to the optical mode mismatch between the optical fiber mode and the rectangular slab waveguide mode. Interconnects designed for out-of-plane coupling to the waveguides are particularly susceptible to high loss conditions. Existing methods to reduce the optical losses include spot size conversion, and/or beam shaping and focusing with micro lens assemblies.

### BRIEF SUMMARY OF THE INVENTION

Embodiments of the present invention are directed to a method of processing an optical fiber to match the optical field coming out of the fiber to that accepted into the optical waveguide to reduce the optical losses due to the optical mode mismatch of the interconnection.

In accordance with an aspect of the present invention, a method of tapering an end of an optical fiber comprises providing a flow of etch vapor from an etch solution generally in an etch vapor flow direction, a concentration of the etch vapor decreasing with distance in the etch vapor flow direction; providing an optical fiber have an end portion with a tip, the end portion of the optical fiber including a core and a clad; and subjecting the end portion of the optical fiber to the flow of etch vapor from the etch solution to etch the end portion and form a taper at the end portion. The end portion is disposed generally along the etch vapor flow direction and the tip of the end portion points generally in a direction opposite from the etch vapor flow direction.

In some embodiments, the etch solution comprises an etchant and a buffer, such as HF and ammonium fluoride. The method may comprise covering a remaining portion of the optical fiber with a protective cover to expose only the end portion of the optical fiber to the etchant. The etch solution is provided at a temperature which is at or above room temperature. The etch solution may be placed in a container. The end portion of the optical fiber is disposed generally vertically above the etch solution with the tip pointing downward. The container is an open container placed in an enclosure which is vented. The tip of the end portion of the optical fiber is etched from an initial diameter of about 125 μm to an etched diameter of about 4 μm. The tapered end of the optical fiber may be coupled with a waveguide oriented generally perpendicular to the waveguide to form an out-of-plane fiber optic interconnection.

In accordance with another aspect of the invention, a method of tapering an end of an optical fiber comprises providing an etch solution in a container at a temperature to produce a flow of vapor from the etch solution; providing an optical fiber have an end portion with a tip, the end portion of the optical fiber including a core and a clad; and positioning the end portion of the optical fiber generally vertically above the etch solution with the tip pointing downward to subject the core and the clad of the end portion of the optical fiber to the flow of vapor from the etch solution to etch the end portion and form a taper at the end portion.

In some embodiments, the etch solution is at or above room temperature. The temperature of the etch solution is substantially constant. The end portion of the optical fiber is generally fixed in position with respect to the container.

In accordance with another aspect of the present invention, a method of tapering an end of an optical fiber comprises removing an outer jacket of an end portion of an optical fiber having a tip to expose a core and a clad; placing the end portion of the optical fiber generally vertically above an etch solution with the tip pointing downward; and controlling a temperature of the etch solution to produce a vapor for etching the end portion of the optical fiber and a position of the end portion of the optical fiber with respect to the etch solution to etch the core and the clad of the end portion of the optical fiber to form a taper at the end portion.

In some embodiments, the etch solution is at or above room temperature. The temperature of the etch solution is substantially constant. The end portion of the optical fiber is generally fixed in position with respect to the etch solution.

### BRIEF DESCRIPTION OF THE DRAWINGS

FIG. 1 is a simplified schematic view of an out-of-plane interconnection between an optical fiber and a waveguide;

FIG. 2 is a view of the tapered end portion of an optical fiber;

FIG. 3 is a plot of the power attenuation versus lateral shift of a tapered fiber end portion;

FIG. 4 is a simplified schematic view of an apparatus for tapering the end portion of an optical fiber according to an embodiment of the present invention;

FIG. 5 is an optical micrograph of a tapered fiber end according to an embodiment of the present invention; and

FIG. 6 is a simplified schematic view of an out-of-plane interconnection between the optical fiber having the tapered end portion and a waveguide according to an embodiment of the present invention.

### DETAILED DESCRIPTION OF THE INVENTION

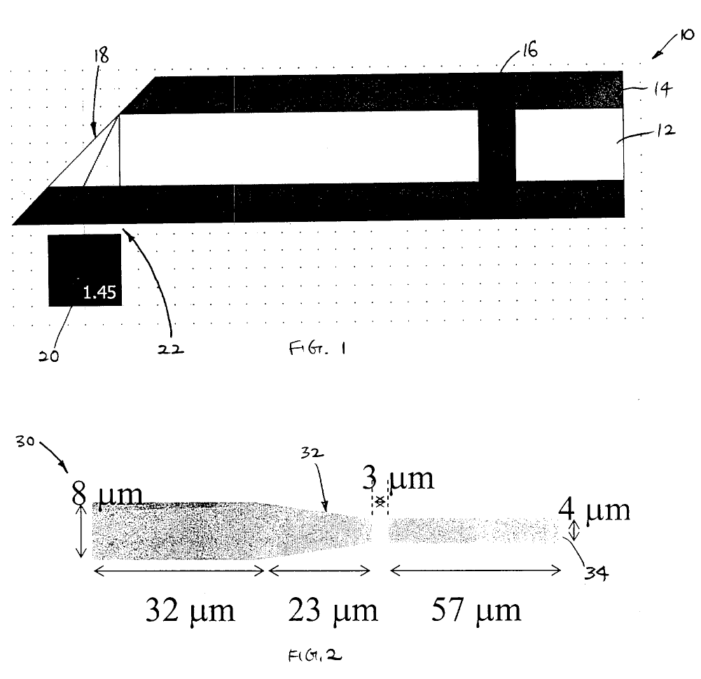

FIG. 1 shows the interconnection for a waveguide 10 which has a core 12 and a cladding 14 sheathing the core 12. The core 12 may be made of glass or the like. The clad may be made of glass or the like. A monitor 16 is typically provided to detect and adjust the emitted optical power. The waveguide 10 has a 45° cut 18 serving as a mirror for an out-of-plane coupling with the fiber end portion 20 of an optical fiber. The fiber end portion 20 is spaced from the waveguide 10 by an air gap 22 which is typically about 1 μm or less. The out-of-plane interconnection as shown is particularly susceptible to high optical loss of about 4 dB due to the optical mode mismatch between the optical fiber mode and the rectangular slab waveguide mode.

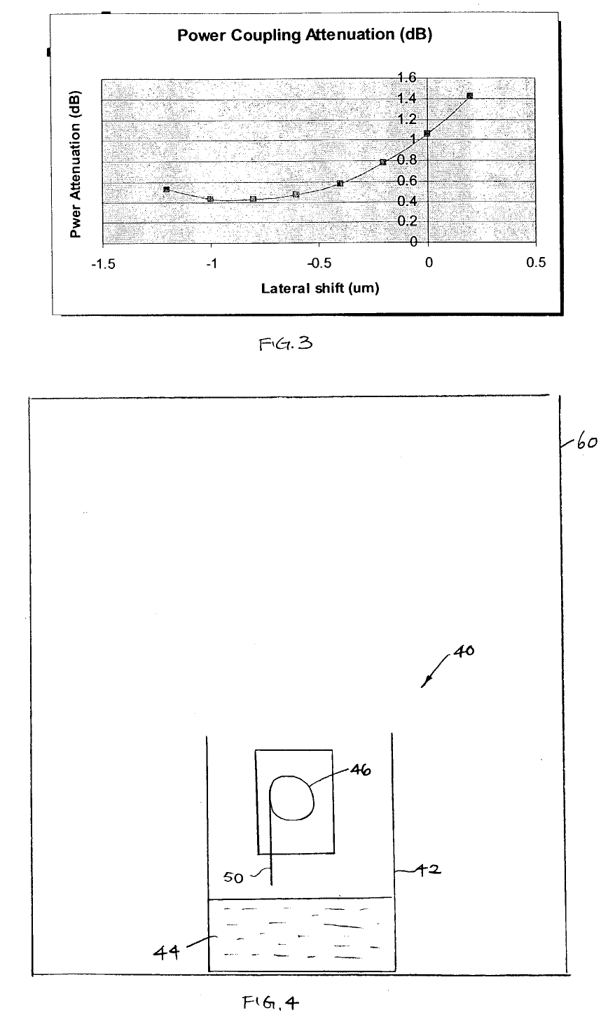

To reduce the optical loss at the interconnection, the fiber end portion of the optical fiber should be shaped to more closely match the waveguide in optical mode. FIG. 2 shows the core of an optical fiber 30 having a fiber end portion 32 which is tapered so that the mode field exiting the fiber 30 is substantially the same as the required input field for the slab waveguide structure. The slab structure of the waveguide is typically elliptical while the cross section of the fiber is circular. To better match the waveguide in optical mode, the fiber end portion 32 is tapered down to a tip 34 from an original core size of about 8 μm to a core size of about 4 μm at the tip 34.

FIG. 3 shows the result of simulations performed using the geometry of the fiber end portion 32 of FIG. 2 and an air gap of about 0.8 μm. The loss characteristics represented by power attenuation is plotted as a function of the position of the taper represented by lateral shift. The simulations show that the optical loss is reduced to about 1 dB or less.

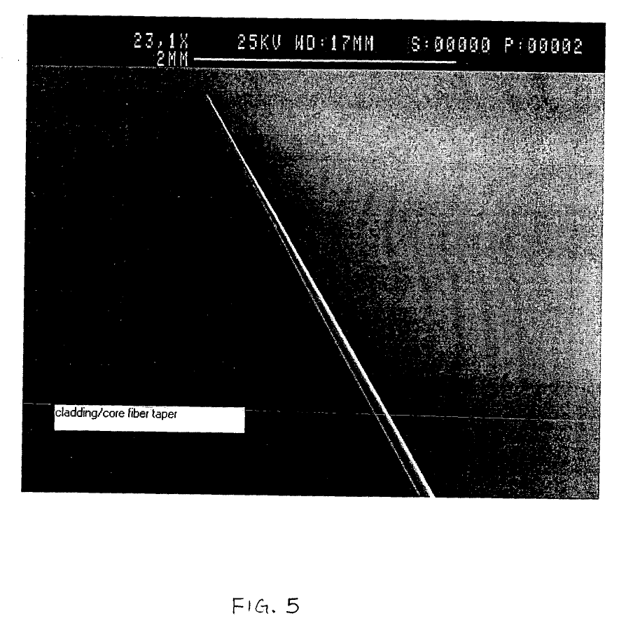

FIG. 4 shows one embodiment of an apparatus 40 to taper the end portion of an optical fiber. The apparatus 40 comprises a container such as a fluoroware beaker 42 holding an etch solution 44 including an etchant and a diluent or a buffer. For example, the etch solution 44 may include about 40-100 percent HF (hydrofluoric acid) as the etchant and the remaining portion is an aqueous solution of ammonium fluoride as the buffer.

An optical fiber 46 is placed above the etch solution. The fiber 46 is typically provided in a coil for ease of handling. To prepare the fiber 46 for etching, a desired length of the fiber is cut. At one end of the fiber 46, a length of the outer jacket is removed using a stripping tool or razor blade or the like to provide an exposed clad/core at the fiber end 50. The exposed fiber end 50 is disposed above the etch solution 44, and is exposed to vapors of the etch solution 44. The tip of the exposed fiber end 50 may be spaced from the etch solution by about 5-10 mm. The position of the exposed fiber end 50 is typically fixed with respect to the container 42 or the etch solution 44 in the container 42. The etch solution 44 may be at room temperature, or may be heated. When heated, the etch solution 44 evaporates more quickly to etch the exposed fiber end 50 at a faster rate to form the taper, although experiments have shown that the etched surface has a higher roughness at a higher etch rate. For an HF etch solution, for example, the temperature may be about 20° C. to 60° C. or higher. The temperature of the etch solution is typically kept constant. The rest of the fiber 46 above the stripped end 50 is desirably protected from the etch vapor (e.g., HF vapor). For example, a plastic bag 54 is placed around the fiber 46 to seal it, and a small notch is cut through which the exposed fiber end 50 protrudes. The exposed end 50 is disposed generally vertically above the etch solution 44 for a period of time until the desired tapered end is formed by etching. As the etch vapor rises from the etch solution, the concentration of the etch vapor decreases with the vertical distance from the surface of the HF solution as the etch vapor mixes with the air or the gases present in and around the container. The vertical orientation of the fiber end 50 ensures that the etch rate is highest at the tip of the fiber end 50 and decreases in the direction away from the tip so as to etch a tapered fiber end 50. The container 42 is desirably placed in a relatively controlled environment such that the etch vapor rises upward generally vertically and steadily without interruption from external air flow or draft. This ensures a well controlled evaporation rate. FIG. 4 shows the container 42 disposed in an enclosure or chamber 60 which has one or more relatively small vents to let the vapor out of the enclosure 60 without causing interruption to the upward vapor flow. The container 60 may be purged between etching procedures using a purge gas such as nitrogen or the like.

The etching component is selected based on the fiber core material to be etched. The concentration of the etching component may be selected based on the desired fiber end portion characteristics and taper angles. The higher the concentration of HF, the lower the etch time is required to form the tapered end portion and the shorter the taper length will be. In one example, an etch time of about four hours is needed to taper the fiber end portion having a glass core and a clad from an initial diameter of about 125 μm to an etched diameter of about 4 μm at the tip using a 40% HF solution, while the etch time is reduced to about one hour using a 100% HF solution. Of course, the etch time depends on the type of fiber used.

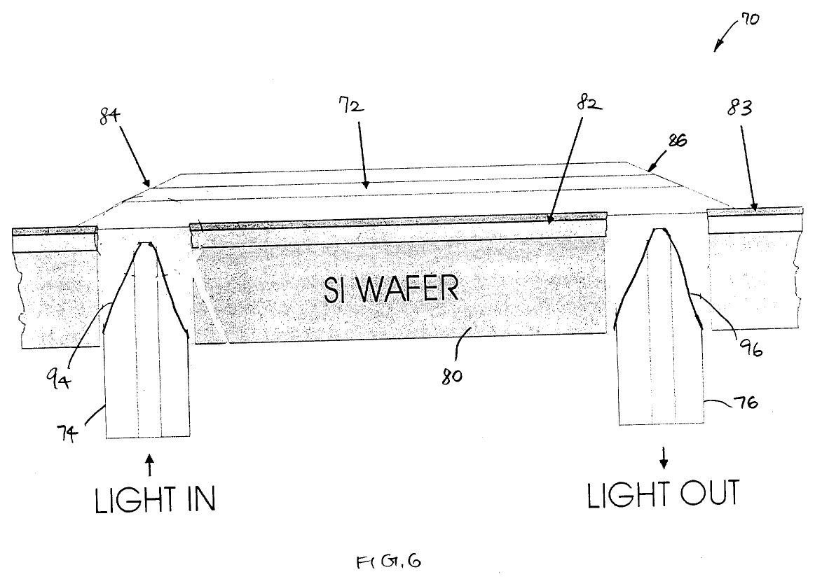

FIG. 5 shows an optical micrograph of a tapered fiber end fabricated using the process described above. The tapered fiber end has a taper angle of about 5° over a length of about 40 μm. The end portion of the glass core is tapered from an original diameter of about 8 μm to a diameter of about 4 μm. The taper is substantially uniform. The surface roughness is about 80 nm. In general, the taper angle may be about 3-7° over a length of about 20-80 μm, and the surface roughness may be about 30-100 nm.

FIG. 6 shows an interconnection 70 between a waveguide 72 and a pair of optical fibers 74, 76. They are coupled to a silicon wafer 80 having a Kapton layer 82 and a metal layer 83 formed thereon and disposed below the waveguide 72. The interconnection 70 is an out-of-plane interconnection. The waveguide 72 includes 45° mirrors 84, 86 near the coupling locations with the optical fibers. The optical fibers 74, 76 include tapered ends 94, 96 at the respective coupling locations with the waveguide 72. Light enters through the first optical fiber 74 and is reflected by the first 45° mirror 84, travels through the waveguide 72, and then is reflected by the second 45° mirror 86 and exits through the second optical fiber 76. Note that the components are not drawn to scale, and certain dimensions such as the sizes of the fibers are exaggerated for ease of illustration.

The use of the optical fiber having the tapered end portion reduces the optical loss at the fiber to waveguide interconnection. It also results in ease of final integration and assembly of the optical system. It is understood that the optical fibers having tapered ends formed according to the present invention may be used in other configurations, including in-plane interconnections.

The above-described arrangements of apparatus and methods are merely illustrative of applications of the principles of this invention and many other embodiments and modifications may be made without departing from the spirit and scope of the invention as defined in the claims. For instance, the flow of the etch vapor may be generated in a direction that is not necessarily vertical, and the oriented of the end portion of the optical fiber will be adjusted to correspond to the etch vapor flow direction. The scope of the invention should, therefore, be determined not with reference to the above description, but instead should be determined with reference to the appended claims along with their full scope of equivalents.

What is claimed is:

1. A method of tapering an end of an optical fiber, the method comprising:
providing a flow of etch vapor from an etch solution generally in an etch vapor flow direction, a concentration of the etch vapor decreasing with distance in the etch vapor flow direction;
providing an optical fiber have an end portion with a tip, the end portion of the optical fiber including a core and a clad; and
subjecting the end portion of the optical fiber to the flow of etch vapor from the etch solution to etch the end portion and form a taper at the end portion, wherein the end portion is disposed generally along the etch vapor flow direction and the tip of the end portion points generally in a direction opposite from the etch vapor flow direction.

2. The method of claim 1 wherein the etch solution comprises HF.

3. The method of claim 1 wherein the etch solution comprises an etchant and a buffer.

4. The method of claim 3 wherein the etchant comprises HF and the buffer comprises ammonium fluoride.

5. The method of claim 4 wherein the etch solution includes about 40-100% HF.

6. The method of claim 1 further comprising covering a remaining portion of the optical fiber with a protective cover to expose only the end portion of the optical fiber to the flow of etch vapor.

7. The method of claim 1 wherein the etch solution is provided at a temperature which is at or above room temperature.

8. The method of claim 1 wherein the etch solution is placed in a container.

9. The method of claim 8 wherein the end portion of the optical fiber is disposed generally vertically above the etch solution with the tip pointing downward.

10. The method of claim 8 wherein the container is an open container placed in an enclosure which is vented.

11. The method of claim 8 wherein the tip of the end portion is spaced from the etch solution by about 5-10 mm.

12. The method of claim 1 wherein the core comprises glass.

13. The method of claim 1 wherein the tip of the end portion of the optical fiber is etched from an initial diameter of about 8 μm to an etched diameter of about 4 μm.

14. A method of forming a fiber optic interconnection using the optical fiber having the tapered end of claim 1 further comprising coupling the tapered end of the optical fiber with a waveguide oriented generally perpendicular to the waveguide to form an out-of-plane interconnection.

15. A method of tapering an end of an optical fiber, the method comprising:
providing an etch solution in a container at a temperature to produce a flow of vapor from the etch solution;
providing an optical fiber have an end portion with a tip, the end portion of the optical fiber including a core and a clad; and
positioning the end portion of the optical fiber generally vertically above the etch solution with the tip pointing downward to subject the core and the clad of the end portion of the optical fiber to the flow of vapor from the etch solution to etch the end portion and form a taper at the end portion.

16. The method of claim 15 wherein the etch solution is at or above room temperature.

17. The method of claim 15 wherein the temperature of the etch solution is substantially constant.

18. The method of claim 15 wherein the end portion of the optical fiber is generally fixed in position with respect to the container.

19. A method of tapering an end of an optical fiber, the method comprising:
removing an outer jacket of an end portion of an optical fiber having a tip to expose a core and a clad;
placing the end portion of the optical fiber generally vertically above an etch solution with the tip pointing downward; and
controlling a temperature of the etch solution to produce a vapor for etching the end portion of the optical fiber and a position of the end portion of the optical fiber with respect to the etch solution to etch the core and the clad of the end portion of the optical fiber to form a taper at the end portion.

20. The method of claim 19 wherein the etch solution is at or above room temperature.

21. The method of claim 19 wherein the temperature of the etch solution is substantially constant.

22. The method of claim 19 wherein the end portion of the optical fiber is generally fixed in position with respect to the etch solution.
